(19) United States
(12) Patent Application Publication
(10) Pub. No.: US 2001/0043742 A1
(43) Pub. Date: Nov. 22, 2001

(54) COMMUNICATION DOCUMENT DETECTOR

(76) Inventor: ROGER D MELEN, LOS ALTOS HILLS, CA (US)

Correspondence Address: FENWICK & WEST LLP, TWO PALO ALTO SQUARE, PALO ALTO, CA, 94306, US

(21) Appl. No.: 09/070,113

(22) Filed: Apr. 29, 1998

(51) Int. Cl. G06K 9/46

(52) U.S. Cl. 382/203

(57) ABSTRACT

Disclosure document (101) is a classified communication document (102) or a non-communication document (104) by extracting (300) image information from a digitized image produced by a scanner (106). The image information is typically extracted after first applying a thresholding module (204) on the digitized image, and then applying a connected component processor (208) to the resulting binarized image. The character image information is compared (304) to stored image information. The stored image information may include criteria such as height, location, and density of the connected components within the image. Depending upon the results of the comparison, the document (101) is then classified (308) as either a communication document (102) or a non-communication document (104). If the document (101) is classified as a communication document (102), the subsequent pages are stored in the same file location as the recognized communication document (102). When a next communication document (102) is recognized, it is stored into a new file location, and its supporting documents (104) are then stored with it. Thus, in accordance with the present invention, a stack of documents (101) containing different communications may be inputted into a scanner (106), and the different communications are recognized and grouped together, without further involvement from the user (160).

### TECHNICAL FIELD

This invention pertains to the field of data storage and filing systems, and more specifically, to those systems employing optical character recognition.

### BACKGROUND ART

In today's society, businesses are increasingly interdependent. Suppliers, distributors, retailers, and even competitors all work together in the marketplace. Businesses must be in constant communication with each other in order to successfully meet their objectives. Communication today may be accomplished in a myriad of methods including faxes, letters, telephone calls, voicemail messages, e-mail messages or personal meetings. Despite the increase in popularity of other communication methods, the overwhelmingly favored method of communication is still the letter. Thus, the need for businesses to communicate leads to millions of letters and other types of communication documents being generated and received every day.

The goal of many businesses, however, is to move to a paperless system. This typically involves digitizing their paper documents, including their communications, through a scanner, and storing the digitized documents on a database. Digitizing documents allows for easy search and retrieval of the documents, and digitized documents occupy less physical space than their paper counterparts. Each communication is typically stored as a separate file on the system for organizational purposes. However, current document imaging systems are not automated. A user must separate out documents that constitute different subject matter in order to store the different communication as different files, which is a lengthy and time-consuming procedure. If the user does not separate out the different communications in a stack of documents prior to scanning the stack of documents, all of the communications are stored together without recognizing that the stack consists of several different communications.

Thus, there is a need for a document imaging system which can distinguish between a communication document and a non-communication document, to allow for a more automated document imaging system.

### DISCLOSURE OF THE INVENTION

The system of the present invention detects whether a document (101) is a communication document (102) or a non-communication document (104). This is preferably accomplished by extracting (300) image information from a digitized image produced by a scanner (106). The image information is typically extracted (300) after first applying a thresholding module (114) on the digitized image, and then applying a connected component processor (208) to the resulting binarized image. The character image information is compared (304) to stored image information. The stored image information may include criteria such as height, location, and density of the connected components within the image. Depending upon the results of the comparison, the document (101) is then classified (308) as either a communication document (102) or a non-communication document (104). If the document (101) is classified (308) as a communication document (102), the subsequent pages are stored in the same file location as the recognized communication document (102). When a next communication document (102) is recognized, it is stored into a new file location, and its supporting documents (104) are then stored with it. Thus, in accordance with the present invention, a stack of documents (1O1) containing different communications may be inputted into a scanner (106), and the different communications are recognized and grouped together, without further involvement from the user (160).

### BRIEF DESCRIPTION OF THE DRAWINGS

FIG. 1 illustrates hardware components of the present invention.

FIG. 2 is a logical block diagram illustrating the processing components of a document imaging system in accordance with the present invention.

FIG. 3 is a flowchart diagram illustrating the process steps of an embodiment of the present invention in which communication documents 102 are recognized.

FIG. 4 is a flowchart diagram illustrating of a more specific embodiment of communication document detection in which connected component data 205 are analyzed and an optical character recognition module 210 is employed.

FIG. 5 is a detailed flowchart diagram illustrating comparing and classifying connected components and documents in accordance with the present invention.

FIG. 6 is a flowchart diagram illustrating the dense region criteria of the present invention.

FIG. 7a is a detailed flowchart illustrating the post-processing functionality of the present invention.

FIG. 7b is an illustration of an exemplary table 140.

FIG. 7c is an alternate embodiment of table 140.

### DETAILED DESCRIPTION OF THE PREFERRED EMBODIMENTS

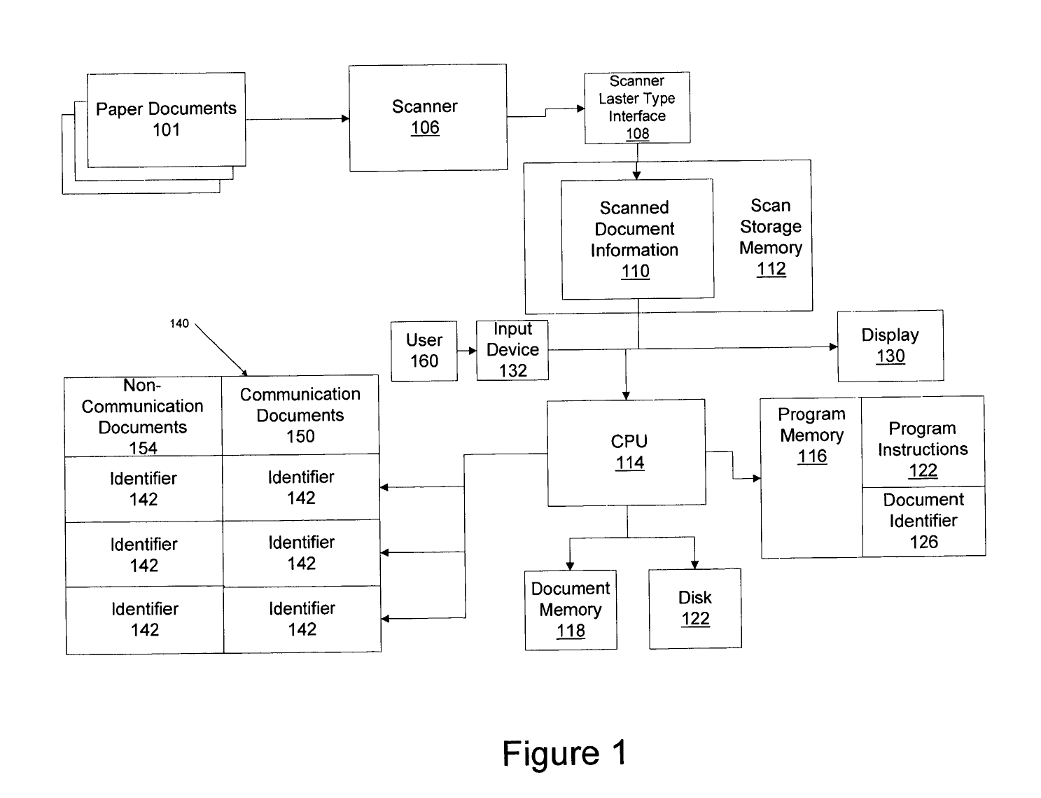

FIG. 1 illustrates a document imaging system in accordance with the present invention. Scanner 106 is a conventional scanner which takes as input paper documents 101 and creates digitized images of the documents in response. The scanner 106 is preferably a dual-side scanner and scans each document page using a CCD line-array to create a gray-scale image of the document 101. Scanner 106 typically produces a header for the created image, unseen by user 160, that contains format information that is used by a central processing unit (“CPU”) 114 in accordance with the present invention, including type of scan, height and width of the image, and value of blackness (0 through 255). Coupled between the scanner 106 and the CPU 114 is scanner interface 108. Scanner interface 108 is a conventional scanner interface which converts commands issued by the CPU 114 into commands recognizable by the scanner 106, and converts information transmitted by the scanner 106 into a protocol recognizable by the CPU 114.

After scanning, the documents 101 are ejected onto a tray upon which the documents 101 are stacked. Documents 101 include communication documents 102 and non-communication documents 104. Communication documents 102 are typically the first page of a set of documents 101. Most communication documents 102 have some type of identifier, such as letterhead. The pages following a communication document 102 are supporting material, which are considered to be non-communication documents 104 for the purposes of the present invention. After being digitized, the document information 1 10 is stored in scan storage memory 112. The scan storage memory is coupled to the CPU 114. Optionally, a microprocessor is coupled to the scanner 106 to provide the scanner 106 with the advanced capabilities of the present invention. However, the processor and peripherals may be physically separate from the scanner 106. The CPU 114 is a conventional microprocessor such as the Intel Pentium processor.

The CPU is coupled to a program memory 116. The program memory 116 stores program instructions 122 and document identifiers 142. Program instructions include the program instructions for performing a thresholding module 204, a connected component processing module 208, and a communication document detection module 212 in accordance with the present invention. The program memory 116 is typically random access memory; however, other types of memory may be used. The information stored in program memory 116 is preferably loaded from a disk 120 by the CPU 114 during the execution of the present invention. Disk 120 stores other programs, such as an operating system and databases.

The program instructions 122 instruct the CPU 114 on what operations to perform on the scanned document information 110. For example, the connected component processor 208 instructs the CPU 114 to recognize connected components from within a binarized image. In accordance with the present invention, a communication document detection module 212 instructs the CPU 114 to classify a document 101 as being either a communication document 102 or a non-communication document 104.

The CPU 114 is also coupled to document memory 118. Document memory 118 stores the different document information after a module has processed a document 101. For example, after the thresholder module 204 is applied to the document information 110, the binarized image is stored in document memory 118. Table 140 is also coupled to CPU 114. Table 140 stores document identifiers 142 in different classifications. Thus, if the CPU 114 determines that a document is a communication document 102, the document identifier 142 of the communication document 102 is placed in the communication document column 150 of table 140. Table 140 is preferably located in disk 120 and is loaded into random access memory upon execution.

Display 130 is a conventional display, and is used to display the digitized images of the documents 102, 104 after being processed by the scanner 106. Additionally, display 130 is used to display the parameters of the communication document detector 212 that are user-definable. Input device 132 provides a user 160 with manual control of the functionality of the CPU 114. The input 132 device may be a keyboard, mouse, or any other cursor locating device.

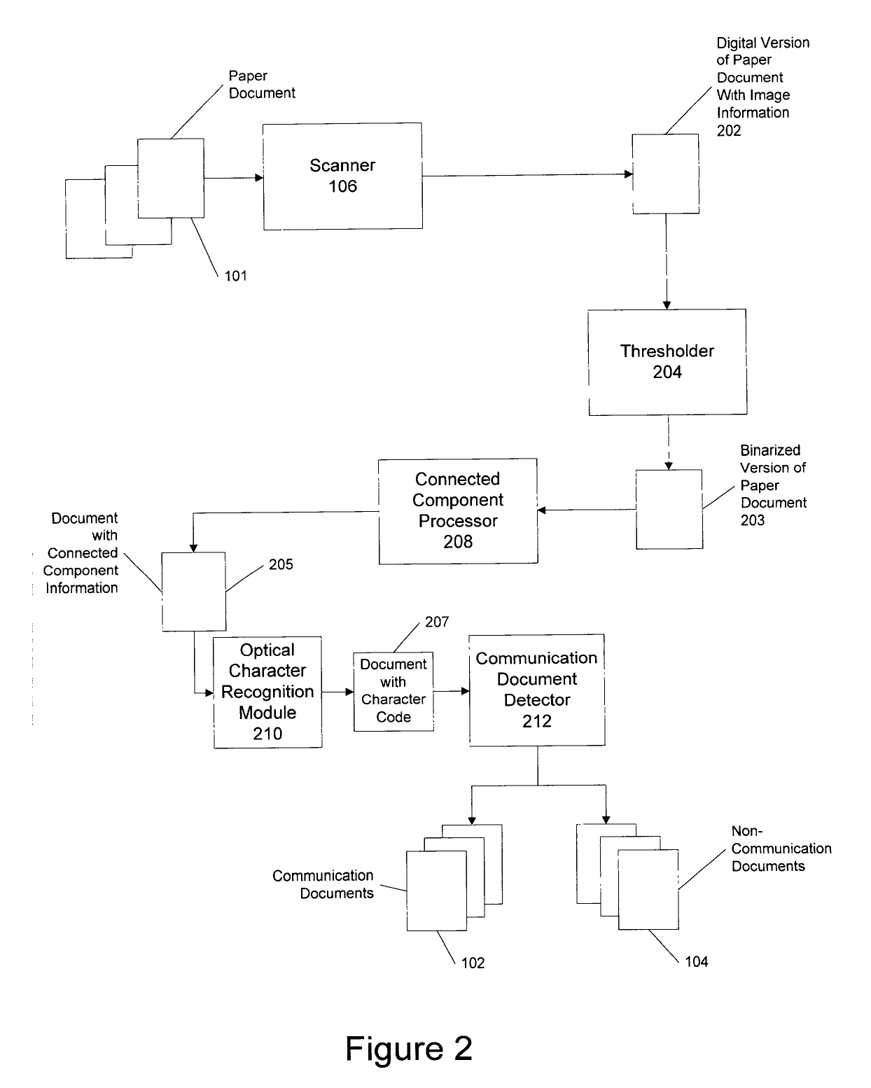

FIG. 2 is a logical block diagram illustrating one embodiment of the processing components of a document imaging system in accordance with the present invention. All of the following modules are preferably applied to process a document 101; however, fewer or different modules may be applied in accordance with the present invention. A paper document 101 is fed into scanner 106. The scanner 106 creates a digital version 202 of the paper document 101 with image information. This scanned document information 110 is stored in scan storage memory 112 as described above. Next, a thresholder module 204 is applied. The thresholder module 204 determines a threshold value of blackness for which to create a binarized image 203. Thresholding is a conventional technique in the art. After thresholding, the binarized image 203 is stored in document memory 118. Then, a connected component processor 208 is applied to recognize connected components within the binarized image 203. A connected component is any group of pixels surrounded by white pixels. Thus, in the word “example!”, there are nine connected components (each letter and the two parts to the exclamation point). The connected component information 205 is stored in document memory 118. An optical character recognition module (OCR) 210 is applied to the connected component data 205 to generate character code and a confidence factor for the recognition of the document 101. The communication document detection module 212 is applied using the recognized document 207 and the connected component data 205 to determine whether the document 101 is a communication document 102 or a non-communication document 104.

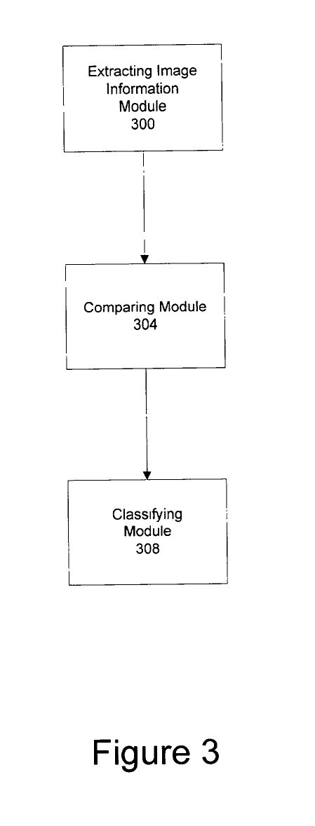

FIG. 3 illustrates an overview of the processing in the preferred embodiment of communication document detection module 212. The process begins with extracting image information from the document 101 using an extracting image information module 300. The image information preferably comprises information concerning the layout and characteristics of the text contained in the document 101. Image information may be gathered in many different ways. One method is to use the information gathered from the connected component processing module 208. However, other sources of image information may be used, gathered prior to or after the connected component processing stage of the document imaging process. For example, information gathered from an optical character recognition module 210 may be used to classify a document 101 as a communication document 102 in accordance with the present invention. Or, information gathered from the document information created by the scanner 106 may be used to classify a document 101 as a communication document 102.

After the image information is extracted, the extracted information is compared with stored image information by a comparing module 304. The stored image information are criteria used to distinguish communication documents 102 from non-communication documents 104. Typical criteria used in accordance with the present invention are the size of characters, the font or typeface of characters, the location of characters, etc.

Next, a classification module 308 classifies the document 101 as a communication document 102 or a non-communication document 104 in response to the comparison. The documents 101 are then stored or processed in accordance with their status. The above module may be implemented as hardware, software, or firmware in accordance with the present invention.

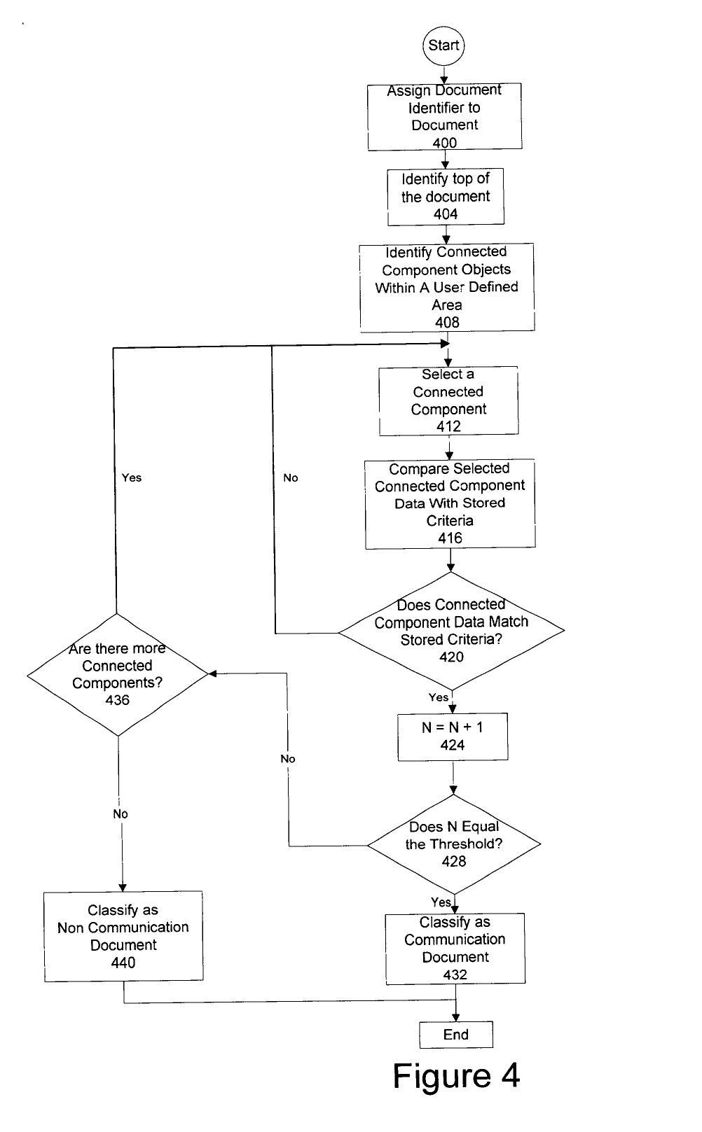

FIG. 4 is an illustration of a more specific embodiment of communication document detection in which connected component data 205 are analyzed and an optical character recognition module 210 is employed to distinguish between communication documents 102 and non-communication documents 104. The system begins by assigning 400 a document identifier 142 to the document 101. This document identifier 142 allows the system to store, track, and retrieve the document 101 within the database or computer system. By using the document identifiers 142, any subsequent pages 104 related to a communication document 102 may be associated with the communication document 102.

The system next identifies 404 the top of the digitized image. In order to identify the top of the image, the system first determines the proper orientation of the image. This is preferably accomplished by allowing the OCR 210 to process the image in all four possible orientations. The OCR 210 generates a recognition confidence factor for each of the orientations. The orientation of the image which yields the highest confidence factor is considered to be the correct orientation. This is due to the fact that the OCR 210 does not recognize characters correctly if the orientation of the image is incorrect, and thus generates a low confidence factor for the incorrect orientations. Once the image is known to be in the proper orientation, the top of the image can be identified.

The system identifies 408 connected components located within a user-defined area, extending from the top of the document to a user-set constant. Letterhead is typically located at the top of documents 101 and may extend down several inches. Therefore, the connected components of interest in a document 101 are located in the area at the top of the document. If the components at the top of the document match the stored criteria characterizing letterhead, the document is most likely a communication document 102. In the preferred embodiment, the user 160 sets the location of the bottom of the target area to a value that characterizes the types of letterhead that the user 160 typically receives. A default setting, such as 2 inches, may also be used. Thus, using the default value, all connected components located within the top two inches of the document are analyzed to determine if the document is a communication document 102.

The location of the connected components within the image is determined by using the connected component information 205. The connected component processor 208 provides a list of connected component information 205. A preferred connected component processor 208 is illustrated in co-pending application “Page Segmentation and Character Recognition System,” Ser. No. 08/228,359, filed on Apr. 15, 1989, which is hereby incorporated by reference. Typically, a connected component processor 208 assigns all “black” pixels (as determined by the thresholder 204) to a connected component and creates bounding boxes around each connected component. The size of each connected component and their location may be calculated knowing the scanner photosensor density in pixels per inch. For example, if a scanner 106 scans at 100 dots per inch, and a connected component has 100 pixels aligned vertically, the system knows that the connected component is one inch high. Once the orientation of the page is known, the location of the components on the image in inches is similarly determined by determining how many pixels a connected component is from the top or sides of the image, and converting pixels to inches using the scanner photosensor density.

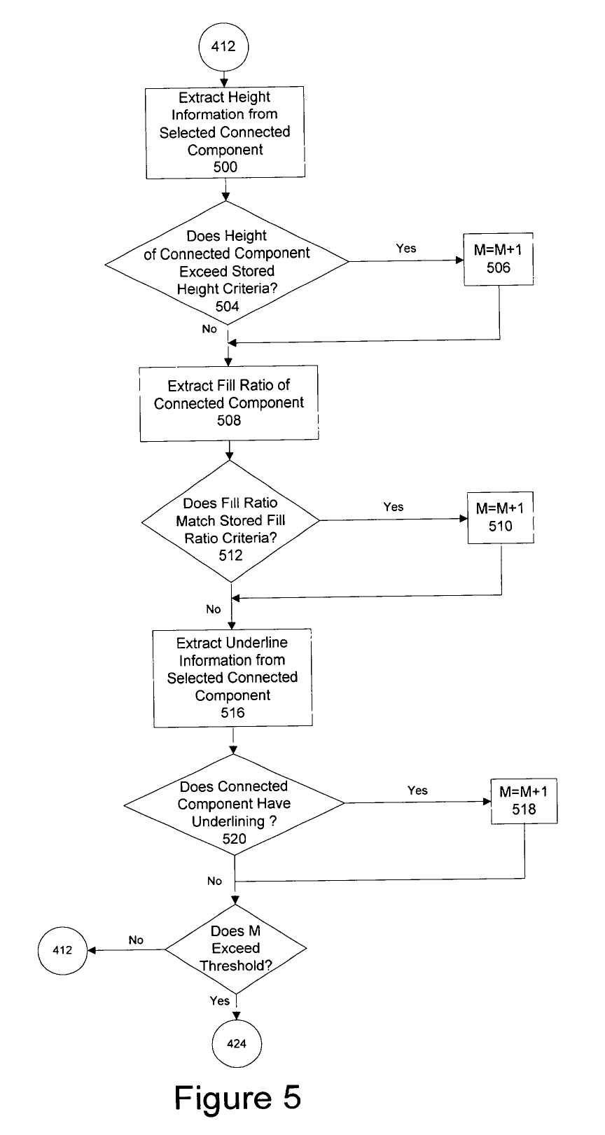

After the connected components within the user-defined area as defined by the user-defined distance are identified 408, the individual components are analyzed to determine whether they match stored criteria. First, a connected component within the user-defined area is selected 412. Then, the selected connected component is compared 416 to the stored criteria. The stored criteria are used to recognize the characteristics of communication documents 102. For example, letterhead typically has unique features, such as bold, large print, more dense printing, underlining, and blocks of space between the letterhead and the beginning of the text of the letter. The comparison process is described in more detail in conjunction with FIG. 5.

If the system determines 420 that the connected component information matches the stored criteria, a counter is increased 424. The system determines 428 whether the counter has reached a threshold. If the counter has not, the system determines 436 whether there are more connected components that have not been analyzed within the user-defined area. If there are more connected components within the user-defined area, a next connected component is selected 412, and the process is repeated. If there are no more connected components within the area, the document is classified 440 as a non-communication document 104. If the system determines that the counter has reached the threshold, the document is classified 432 as a communication document 102.

The threshold is set to determine the number of components required to match the stored criteria before classifying 432 the document as a communication document 102. For example, if the user 160 decides that one match is needed prior to classifying a document 101 as a communication document 102, the threshold is set to one. In this example, if the first connected component matches the stored criteria, the document 101 is classified and the process stops. This setting allows for a faster processing time. However, a low threshold may generate inaccurate results. A non-communication document 104 may have some connected components matching the stored criteria in the top of the document 101, and therefore be erroneously classified. For example, if the sole criteria were bold, a single bold letter in the top of the document 101 would result in the classification of a document 101 as a communication document 102. However, by requiring that a higher number of components match the stored criteria, the user 160 may be assured that the document 101 is truly a communication document 102. Thus, in the above example, if the threshold were ten, then ten connected components would have to be bold before a document 101 is classified as a communication document 102. In an alternate embodiment, all connected components in the user-defined area are analyzed and no threshold is used. This provides for greater accuracy; however, processing time is increased.

The comparison of the connected component to the stored criteria and determination of whether the component matches the stored criteria is preferably performed in accordance with FIG. 5. In FIG. 5, several criteria are listed; specifically, height, underlining, and bold. However, this list of criteria is not meant to be an exhaustive list of the criteria that may be used to distinguish a communication document 102 from a non-communication document 104. Other criteria may be used consistent with the scope of the present invention, some of which are discussed below.

The system first extracts 500 height information from the connected component information of the selected connected component. The height information is calculated as described above, by determining the number of pixels extending along the vertical axis, and dividing the number of pixels by the scanner photosensor density. The height of the selected connected component is compared to the stored height criteria. If the system determines 504 the height of the selected connected component exceeds the stored height criteria, a counter is increased 506 and the system moves to the next stored criteria. If the height did not exceed the stored criteria, the counter is not increased, and the system moves on to the next criteria. Typically, the connected components in letterhead are larger than normal text. Therefore the stored height attribute criteria should be set to a height that is greater than the height of a normal capital letter.

The next criterion in this embodiment is fill ratio. Fill ratio characterizes the thickness of the lines that comprise the connected component. Characters in bold have higher fill ratios than characters in a normal typeface. Typically, letterhead has some characters in bold. Therefore, the fill ratio of the connected component is extracted 508, and the fill ratio of the selected connected component is compared 512 to a pre-defined fill ratio that approximates the bold typeface. If the fill ratio of the connected component exceeds the stored fill ratio, a counter is increased 510 and the system proceeds to the next criteria. Fill ratio or bold typeface information is available to the communication document detection module 212 from the OCR 210, which recognizes bold characters and generates fill ratio information.

The next criterion is underlining. Underlining information is also available from the OCR processing and is extracted 516 therefrom. If the selected component has underlining 520, a counter is increased 518. In an alternate embodiment, a component is tested to determine if the component itself is an underline, and if so, the horizontal length of the component is also determined. The presence of a component which is a long underline in the top of the document 101 is a good indication that the document 101 has letterhead. The counter is then compared to a threshold. The threshold is a user-defined number which sets the amount of criteria that must be met before a document 101 may be determined to have “matched” the stored criteria. Some users 160 may require that all criteria be fulfilled before a component is determined to have matched the stored criteria. Others may require fulfilling only one or two criteria before determining the component matches the criteria. If the threshold is exceeded, the system increases 424 the counter that tracks how many components match the stored criteria. If the threshold is not exceeded, the system returns to step 412 and selects another connected component.

There are other criteria that are equally useful in distinguishing a communication document 102 from a non-communication document 104. These criteria involve examining regions of the document 101. In one embodiment, the system examines the lower section of the image prior to classifying the document 101 as a communication document 102 or a non-communication document 104. There are characteristics of text in the lower section of a communication document 102 that may be used as criteria for distinguishing communication documents 102 from non-communication documents 104. For example, the lower section of a typical communication document 102 typically has characters that are smaller in size than characters in the top of the communication document 102. Thus, height attributes of the components in the lower section are compared with a threshold to determine if any of the components exceed the maximum height criteria. The threshold may be user-defined or may be set to a default value, such as 13 points. If the components in the lower section of the image are smaller than the threshold, the document 101 is classified as a communication document 102.

Another criterion may be the presence of a region of white pixels between the lowest component in the top of the document 101 and the highest component in the lower section of the document 101. Letterhead of a document 102 is usually followed by blank spaces before the body of the communication begins. The connected component processor generates a pixel list including whether the pixels are white. Therefore, this information is used to determine whether there is a white region after the letterhead. If a document 101 has a white region, the document 101 may be classified as a communication document 102 by the present invention.

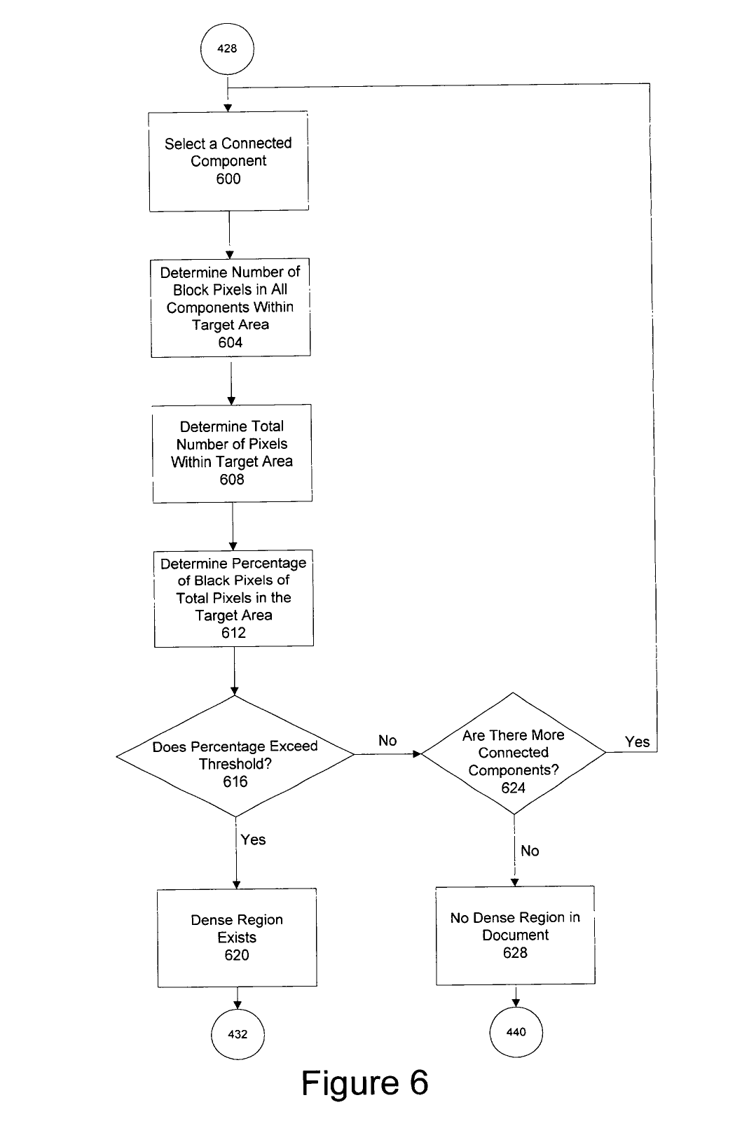

A third criterion is the existence of a dense region of black pixels in the top of the document 101 as illustrated in FIG. 6. Dense regions are regions having a percentage of black pixels greater than a threshold for a given target area. For example, if the threshold was 70% for an area of two inches by three inches, then a region is considered dense if the region is less than or equal to two inches by three inches and has percentage of black pixels greater than 70%. A dense region of black pixels is another good indication of the presence of a logo or letterhead. For this criterion, the locations of the connected components and their bounding boxes in the user-defined area are determined. A first connected component is selected 600. All of the connected components within the target area surrounding the selected connected component are examined to determine 604 the number of black pixels contained within their bounding boxes. The target area is preferably user-specified in accordance with the typical letterhead that is to be digitized in the system. In the above example, the target area is 2 inches by 3 inches, and therefore all components within an area of 2 inches by 3 inches centered around the selected connected component are examined. Then the total number of black pixels in the target area is determined 608, and the percentage of black pixels in the target area is determined 612. The system determines 616 if this percentage exceeds the threshold. If it does, the system determines 620 that a dense region has been found. If the percentage does not exceed the threshold, the system determines 624 if there are any more connected components in the target area. If there are, the next connected component is selected 600 and the process is repeated. If there are no more connected components in the user-defined area, the system determines 628 that the top of the document 10 1 does not have a dense region. This fact is used to help classify the document 101 as being a communication document 102 or a non-communication document 104.

In another embodiment, the system analyzes the lower section of the document 101 to determine the number of black pixels in the lower section of the document 101. If the number of black pixels in the lower section exceeds a threshold percentage of the total pixels in the document 101, the document 101 is classified a non-communication document 104. The threshold percentage is preferably user-defined. For example, the user 160 could define the threshold to be ten per cent. Then, the system determines the total number of pixels in the document 101, and determines ten per cent of that number. That number is used as the threshold amount of black pixels allowed in the lower section of the document 101. Thus, if a document 101 has 100,000 pixels, the threshold number is 10,000. The system then determines the number of black pixels in the lower section of the document 101. If that number exceeds 10,000, then the document 101 is most likely a non-communication document 104. If the number is less than 10,00, the document 101 is most likely a communication document 102. This criterion may be used as one of several criteria to decide if a document 101 is a communication document 102 or a non-communication document 104.

Processing for the above criteria may be accomplished in a similar manner as for the top of the document 101. Counters may be used to require that all or several of the different criteria must be met prior to the document 101 being classified as a communication document 102.

In a preferred embodiment, a quality control measure is used to ensure that the system is correctly recognizing communication documents 102. After a document 101 is classified as a communication document 102, the image of the document 102 is displayed to the user 160. The user 160 can then determine if the document 101 was correctly recognized. If the document 101 was not recognized correctly, the user 160 can change the user-defined parameters described above to improve the recognition of the system. Other forms of quality control feedback may also be used in accordance with the present invention.

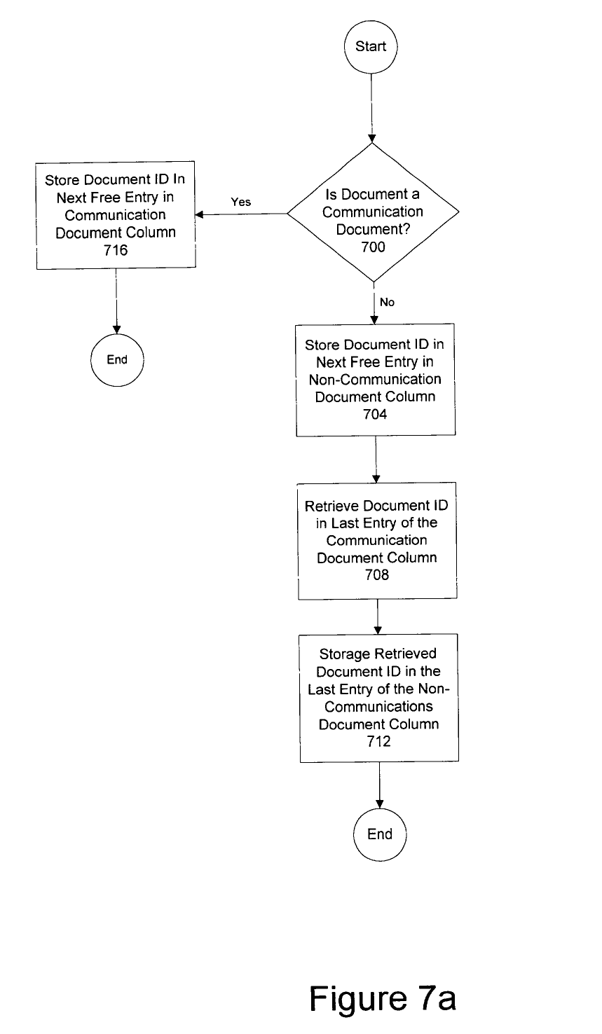

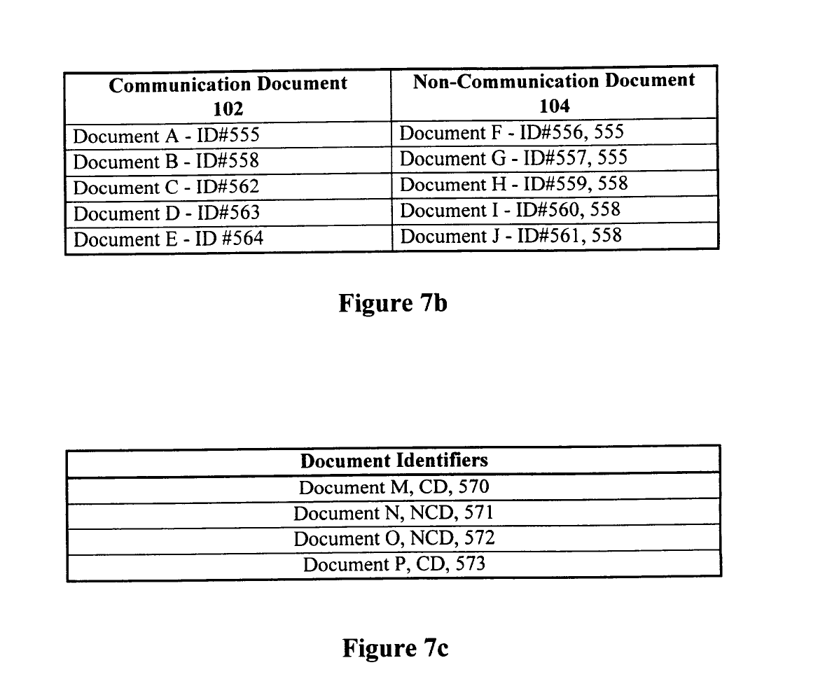

Finally, the present invention processes the document 101 in accordance with its classification as shown in FIG. 7a. The system determines 700 whether a document 101 has been classified as a communication document 102. If it has, the document identifier 142 of the document 102 is placed 716 in next free entry of the communication document column 150 of table 140. If the document 101 has been classified as a non-communication document 104, the document identifier 142 of the document 104 is placed 704 into the next free entry in the non-communication document column 154 of table 140. Next, the document identifier 142 of the last entry in the communication document column 150 is retrieved 708. The retrieved document identifier 142 is then stored 712 with the previously stored non-communication document identifier.

For example, FIG. 7b illustrates a table 140 containing document identifiers 142 for several documents 101. A first document A has been classified a communication document 102 and has been assigned a document identifier of 555. The other documents 101 listed in the communication document column 150 are also communication documents 102 and have document identifiers 142. The documents 101 listed in the non-communication document 104 also have document identifiers 142. However, they are also stored with an extra document identifier 142. This extra document identifier 142 serves as a link to the communication document 102 to which the document 104 relates. For example, documents F and G relate to document A. When user 160 scans in document A, the system classifies document A as a communication document 102. When documents F and G are scanned into the system immediately following A, due to their position in the stack of documents 101, the system recognizes and classifies Documents F and G as non-communication documents 104 and stores their document identifiers in the non-communication document column 154. Then, in accordance with the process described in FIG. 6a, the system retrieves Document A's identifier, which at that time was the last entry in the communication document column 150. The system stores Document A's identifier 555 with Document F and Document G, providing a link between Document F and Document A and Document G and Document A.

In order to preserve the order of the images, links to a previous non-communication document 104 may also be stored. Thus, in this embodiment, Document G would have a third identifier, 556, which identifies that Document F was scanned into the system immediately prior to it. In accordance with this embodiment, if the user 160 wants to see only communication documents 102 without their supporting documents 104, the system can simply retrieve all of the image identified in the communication document column 150. This may occur when the user 160 is simply trying to locate one of several communication documents 102, and can identify the document 101 by looking at the cover page. When the user 160 selects one of the images of the communication documents 102, the images for the supporting non-communication documents 104 are retrieved via table 140 as well. For example, when someone wishes to retrieve document A, the system retrieves document A as well as all of the other documents 104 which have document A's identifier. Alternatively, in an embodiment where the system stores document A into a particular database, all of the documents 104 having document A's identifier are also stored in the same database.

There are a myriad of other methods of post-processing classified documents 101 and using table 140 which will be readily apparent to one of ordinary skill in the art after reading the disclosure of the present invention. For example, table 140 may have only one column, which contains a document identifier 142 and an indicator indicating whether or not the document 101 is a communication document 102 or a non-communication document 104. In this embodiment as illustrated in FIG. 7c, for example, a Document M is classified as a communication document 102. Then, two non-communication documents 104 are received and classified. Finally, a next communication document 102, Document P, is received and classified. The system groups together Document M and the non-communication documents 104 located between Document M and the next communication document 102 as being one communication that may be stored and retrieved together on the system.

In an alternate embodiment in which non-communication documents 104 are inputted onto a system that do not correspond to any communication document 102, a control sheet whose layout mimics a communication document 102 to organize the non-communication document 104 may be used. Or, the present invention may be configured to operate when a user 160 knows that the stack of documents 101 to be inputted only contains communications. If non-communication documents 104 that do not correspond to communication documents 102 are to be inputted, the present invention may be disabled, and the documents 101 can be processed in a traditional manner.

The above description is included to illustrate the operation of the preferred embodiments and is not meant to limit the scope of the invention. The scope of the invention is to be limited only by the following claims. From the above discussion, many variations will be apparent to one skilled in the art that would yet be encompassed by the spirit and scope of the present invention.

What is claimed is:

1. In a document imaging system, wherein documents are scanned to create images of the documents, a method for recognizing documents used for communication, said method comprising the steps of:
extracting image information from the scanned document;
comparing the extracted image information to stored image information; and
classifying the scanned document as a communication document responsive to the results of the comparison between the extracted image information and the stored image information.

2. The method of claim 1 wherein the image information comprises height, position, pixel density, and typeface of the characters within the image.

3. The method of claim I wherein a document containing letterhead is designated to be a communication document.

4. The method of claim I wherein the documents have connected components, and the connected components have height information, said method further comprising the steps of:
identifying a top of the image of one of the scanned documents;
identifying connected components located within a user-defined distance from the top of the image; and
selecting a connected component from the identified connected components;
wherein
the extracting image information step comprises extracting height information from the selected connected component;
the comparing extracted image information step comprises comparing the height information of the selected connected component to a height threshold; and
the classifying the scanned document as a communication document step comprises, responsive to the height information of the selected connected component exceeding the height threshold, classifying the document as a communication document; and said method further comprises the step of:
repeating the selecting a next identified connected component, extracting the height information, comparing the height, and classifying steps responsive to the height information of the connected component being less than the height threshold, until one or all of the conditions in the following set of conditions has been satisfied:
a) all of the identified connected components have been selected;
b) the document has been classified as a communication document.

5. The method of claim 4 further comprising the step of:
responsive to all of the identified connected components having been selected and
the document having not been classified as a communication document,
classifying the document as a non-communication document.

6. The method of claim 4 further comprising the step of:
identifying the existence of a dense region of black pixels within the user-defined distance from the top of the image; and wherein
the classifying the scanned document as a communication document step comprises, responsive to the height information of the selected connected component exceeding the height threshold and determining that a dense region of black pixels exists, classifying the document as a communication document.

7. The method of claim 4 further comprising the steps of:
displaying the image of the document in response to the document being classified as a communication document; and
receiving input corresponding to the user-defined distance and height threshold.

8. The method of claim 4 wherein the connected components have typeface information, and the extracting image information step further comprises extracting typeface information for the selected connected component, said method further comprising the steps of:
responsive to the height information of the selected connected component exceeding the threshold, increasing a value of a first counter;
comparing the typeface information of the selected connected component to a stored typeface criterion; and
responsive to the typeface information of the selected connected component matching the stored typeface criterion, increasing the value of the first counter; wherein
the classifying step further comprises classifying the document as a communication document responsive to the value of the first counter exceeding a pre-defined threshold; and
the repeating step further comprises repeating the selecting a next identified connected component, extracting the height and typeface information, comparing the height, increasing a value of a first counter responsive to the height information, comparing the typeface, increasing the value of the first counter responsive to the typeface information, and classifying steps until one or all of the conditions in the following set of conditions has been satisfied:
a) all of the identified connected components have been selected;
b) the document has been classified a communication document.

9. The method of claim 8 wherein the stored typeface criterion is bold.

10. The method of claim 8 wherein the pre-defined threshold is defined by a user of the system.

11. The method of claim 8 further comprising the steps of:
responsive to the value of the first counter exceeding the pre-defined threshold, increasing a value of a second counter, wherein
the repeating step comprises repeating the selecting a next identified connected component, extracting the height and typeface information, comparing the height, increasing a value of a first counter responsive to the height information, comparing the typeface, increasing the value of the first counter responsive to the typeface information, and increasing the value of a second counter steps, until one or all of the conditions in the following set of conditions has been satisifed:
a) all of the identified connected components have been selected;
b) the document has been classified a communication document; and
the classifying step comprises classifying the document as a communication document in response to the value of the second counter exceeding a pre-defined limit.

12. The method of claim 8 wherein the connected components have underlining information, and the extracting image information step further comprises extracting underlining information for the selected connected component, said method further comprising the step of:
responsive to the underlining information of the selected connected component matching the stored underlining criterion, increasing the value of the first counter; and wherein
the repeating step further comprises repeating the extracting the height, typeface, and underlining information, comparing the underlining information, and increasing the value of the first counter responsive to the underlining information.

13. The method of claim 4 wherein a document is divided into two sections, a first section being a portion of the image located between the top of the document and the position in the document specified by the user-defined distance, and a second section being a portion of the image located between the position in the document specified by the user-defined distance and a bottom edge of the document, said method further comprising the steps of:
determining a pixel density of the second section of the document; and
comparing a pixel density of the second section to a threshold image density; wherein
the classifying step further comprises, responsive to the pixel density of the second section being less than the threshold pixel density and the height information of the selected connected component exceeding the threshold, classifying the document as a communication document.

14. The method of claim 13 wherein the threshold pixel density is defined by a user of the system.

15. The method of claim 13 further comprising the steps of:
determining the location of a lowest connected component in the first section of the document;
determining the location of a highest connected component in the second section of the document;
determining the distance between the lowest connected component in the first section of the document and the highest connected component in the second section of the document responsive to the determined locations; and
comparing the determined distance to a threshold; wherein
the classifying step further comprises, responsive to the distance exceeding the threshold, classifying the document as a communication document.

16. The method of claim 1 in a system in which multiple communication documents are inputted into a scanner, and non-communication documents relate to a specific communication document, said method further comprising the steps of:
classifying the scanned document as a non-communication document in response to the document not being classified as a communication document; and
responsive to the scanned document being classified as a non-communication document, providing a link between the scanned document and the specific communication document to which the non-communication document relates.

17. An apparatus for recognizing documents used for communication, comprising:
an image information extraction module, for extracting image information from a document;
a memory, coupled to the image information extraction module, for storing the extracted image information and stored image criteria;
a comparator, coupled to the memory, for comparing the extracted image information and the stored image information; and
a central processing unit, coupled to the comparator, for classifying the document, as a communication document in response to an output of the comparator.

18. A computer readable medium containing a computer program for processing documents in a document imaging system, wherein a paper copy of the document to be processed is transformed into a digital version of the document, and the computer program causes the processor to extract image information from the digital version of the document, compare the extracted image information to stored image information, and classify the document as a communication document in response to the results of the comparison.
